(19) United States
(12) Patent Application Publication
(10) Pub. No.: US 2011/0304584 A1
(43) Pub. Date: Dec. 15, 2011

(54) TOUCH SCREEN CONTROL METHOD AND TOUCH SCREEN DEVICE USING THE SAME

(76) Inventor: Sung Jae Hwang, Daejeon (KR)

(21) Appl. No.: 13/202,766

(22) PCT Filed: Jun. 3, 2009
(86) PCT No.: PCT/KR09/02962

§ 371 Date: Aug. 31, 2011

(30) Foreign Application Priority Data
Feb. 23, 2009 (KR) 10-2009-00147769
Apr. 6, 2009 (KR) 10-2009-0029213
Apr. 6, 2009 (KR) 10-2009-0029214
May 11, 2009 (KR) 10-2009-0040647

(51) Int. Cl. G06F 3/045; G06F 3/041

(52) U.S. Cl. 345/174; 345/173

(57) ABSTRACT

Provided are a touch screen control method and a touch screen device using the same. The touch screen control method according to the present invention comprises the steps of: generating a mark on a virtual touch position, which corresponds to the touch position of a user according to the touch event conditions of the user; and moving the virtual touch position in response to the touch position movements of the user, thereby performing at least one of the commands below. i) a first command according to the distance change between the user touch position and the virtual touch position or ii) a second command different from the first command, which is executed depending on the change of rotation angle of a user touch. A touch panel input method of the present invention and an apparatus thereof efficiently perform enlargement, reduction, rotation, and the like using only one hand by setting an additional mode which is not a general object movement mode.

### TECHNICAL FIELD

The following disclosure relates to a touch screen control method, and a touch screen apparatus using the same, and more particularly, to a touch screen control method capable of performing various commands only with one hand, and a touch screen apparatus using the same.

### BACKGROUND

Recently, touch screens are widely used as user interfaces of electronic devices. The touch screen is advantageous in that it may give an interface which is deformable and familiar to persons. In order to utilize the advantages of the touch screen better, a user may easily move, enlarge, reduce or rotate an image object displayed on a touch screen. US Patent Publication No. 2008/0122796 discloses a multi touch method as a related art. However, the multi touch method is inconvenience since two fingers must be used. This inconvenience is more serious in the case where a portable small electronic device (e.g., a mobile phone and a digital camera) should be manipulated using only one hand.

As an alternative of the multi touch technique having the above problem, an interaction method based on a gesture of a single touch is disclosed. This gesture-based interaction method should match a touch gesture of a user recognized in a general touch mode with a previously input command gesture. The matching process converts coordinate values of a user input means and their variation values into an equation by using complicated mathematical formulas and algorithms and then compares the equation with a preset equation. In other words, since the gesture-based interaction method executes multi-stage processes of gesture recognition matching command performing, there is a problem in that the command may not be promptly or rapidly performed according to a user touch gesture. Further, the gesture-based interface method should distinguish a common touch gesture of a user from a touch gesture (a command gesture) for performing a previously input command (for example, enlarging, reducing or rotating) as described above. However, this process is very difficult under a current touch interface environment where various and complicated user touch gestures are performed, and causes frequent errors.

Further, in a situation where a plurality of objects is shown in a small touch screen, many touch errors occur when a user makes an input to the touch panel. Therefore, even in this situation, a technique allowing a user to simply zoom in (enlarge) a display of the touch panel with only one hand is necessary. In addition, in the case where a touch screen is manipulated with several fingers, the screen may be hidden by the fingers, which is so-called screen blocking. This problem is more serious when the touch screen is small.

### SUMMARY

An embodiment of the present disclosure is directed to providing a new concept of a touch screen control method which may effectively realize various commands with only one hand.

The present disclosure is also directed to providing a new concept of a touch screen apparatus which may effectively realize various commands with only one hand.

In one general aspect, a touch screen control method includes: generating a virtual touch location corresponding to a touch location according to a touch event condition of a user; and moving the virtual touch location corresponding to the movement of the user touch location to perform at least one of following commands: i) a first command according to the change of a distance between the user touch location and the virtual touch location and ii) a second command according to the change of a rotating angle caused by a touch of the user, which is different from the first command. At this time, a sign may be displayed at the virtual touch location, and in one embodiment of the present disclosure, the touch event condition of the user is that a touch is maintained substantially at the same location over a predetermined time or that a touch pressure of the user is over a predetermined pressure.

In addition, the movement of the user touch location may be dragging, and the virtual touch location may correspond to point symmetry to the user touch location.

In one embodiment of the present disclosure, the sign may be displayed on the touch screen even when the user touch location is moving, and the virtual touch location may be moved along with the movement of the user touch location. In addition, the sign may be partially transparent, or the sign may be partially or entirely translucent.

In another embodiment of the present disclosure, the rotating angle may be calculated from a center point between the virtual touch location and the user touch location, and a moving path of the user touch location or the rotating angle may be displayed on the touch screen. In addition, the amount of the second command performed may be determined in proportion to the amount of the changing rotating angle.

The first or second command may be an object enlarging or reducing command, and in one embodiment of the present disclosure, the first command may be an object enlarging or reducing command. At this time, the object reducing command may be performed when the user touch location moves in a direction where a gap between the user touch location and the virtual touch location decreases, while the object enlarging command may be performed when the user touch location moves in a direction where the gap increases.

In addition, the first or second command may be an object rotating command, and in one embodiment of the present disclosure, the second command may be an object rotating command. At this time, the object rotating command may be performed when the user touch location moves in a direction where an inclination between the user touch location and the virtual touch location changes.

In another embodiment of the present disclosure, the first or second command may be any one of the following commands:

rotation of an object;

switching to a previous or next object;

performing of a previous or next moving picture medium;

rewinding or fast forward of a moving picture medium;

increase or decrease of display or voice information; and

scrolling up or down of a data list.

After the controlling of the touch screen to perform the first or second command, the touch screen control method according to one embodiment of the present disclosure may further include: terminating the controlling of the touch screen in the case where a time gap between the end of a user touch and the restart of the user touch is greater than a predetermined reference time; and keeping the controlling of the touch screen in the case where the time gap is smaller than the predetermined reference time. At this time, the sign may slowly disappear when the controlling of the touch screen is terminated.

In addition, the touch screen control method according to one embodiment of the present disclosure may further include controlling the touch screen so that the object is moved along with the movement of the user touch location, without displaying the sign in the case where the touch of the user does not correspond to the touch event condition.

In another general aspect, a touch screen control method includes: generating a virtual touch location at the same location as a first touch location of a user input means; moving the virtual touch location symmetrically to a moving direction of the user input means based on the first touch location as the user input means moves; and enlarging or reducing a screen in correspondence with the change of a distance between the user input means and the virtual touch location.

Here, the virtual touch location may be generated when the user input means touches the first touch location over a predetermined time, when a touch pressure of the user input means is over a predetermined pressure, or when the first touch location of the user input means is within a specific region on the display.

In one embodiment of the present disclosure, the virtual touch location may extend to the outside of the display, and the generating of the virtual touch location may further include generating a recognizable sign at a location where the virtual touch location is generated.

In another general aspect, a touch screen apparatus includes: a touch sensor for sensing a touch on a touch screen; a controller for calculating and generating a virtual touch location corresponding to a user touch location in the case where a touch of a user sensed by the touch sensor corresponds to a preset event condition, and performing at least one of the following commands: i) a first command according to the change of a distance between the user touch location and the virtual touch location; and ii) a second command performed according to the change of a rotating angle of the user touch location and different from the first command; and a display controlled by the controller to display a sign at the virtual touch location and to display an object to which the command is performed.

In one embodiment of the present disclosure, the touch event condition of the user may be that a touch is maintained substantially at the same location over a predetermined time or that a touch pressure of the user is over a predetermined pressure. At this time, the rotating angle may be calculated from a center point between the virtual touch location and the user touch location, and a moving path of the user touch location or the rotating angle may be displayed on the touch screen. In one embodiment of the present disclosure, the amount of the second command performed may be determined in proportion to the amount of the changing rotating angle. In addition, the virtual touch location may correspond to point symmetry to the user touch location, the first command may be an object enlarging or reducing command, and the second command may be any one of rotation of an object; switching to a previous or next object; performing of a previous or next moving picture medium; rewinding or fast forward of a moving picture medium; increase or decrease of display or voice information; and scrolling up or down of a data list.

The touch screen control method and the touch screen apparatus according to the present disclosure allow a user to effectively enlarge, reduce or rotate an object only with a single hand by setting a separate mode different from a common object moving mode. Further, in this mode, various commands may be effectively and rapidly performed by means of the movement of a touch of a user, particularly by means of the movement of a touch which generates a rotating angle of the user touch. In particular, in a general gesture-based interface method, a common touch gesture of a user (e.g., a movement of an object) and a touch gesture for performing a previously input command (for example, rotation) should be classified in the same mode, but it is very difficult to distinguish a common touch gesture from a touch gesture for performing a previously input command under an actual mobile environment, so a complicated algorithm is used for the distinguishing work. In particular, in a restricted computing condition of a mobile device, such a complicated process results in a low processing rate, and this gives much inconvenience to the user. However, in the present disclosure, the movement of a touch is distinguishably separated and performed in two modes (a common mode and a virtual mode), and particularly a command is performed based on a simple touch pattern, namely the change of a rotating angle, so the existing problems are dramatically solved.

In addition, the touch screen control method and the touch screen apparatus according to the present disclosure have advantages in that an image object may be moved, enlarged, reduced or rotated in a single touch manner (for example, a touch is made using one finger). In particular, in the case of a portable small electronic device according to the present disclosure, a user may advantageously move, enlarge, reduce or rotate an image object by using only a thumb of the hand gripping the portable small electronic device. In addition, since the touch screen control method, the touch screen apparatus and the portable small electronic device according to the present disclosure are operated in a single touch manner, an area hidden by a finger(s) is smaller than that of a general technique. Further, since the touch screen control method, the touch screen apparatus and the portable small electronic device according to the present disclosure display a sign (for example, a finger shape) at the virtual touch location, a user familiar to a multi-touch method may easily use the present disclosure. In addition, the multi-touch method frequently demands hardware (e.g., a multi-touch screen panel) supporting the multi-touch method, but the touch screen control method, the touch screen apparatus and the portable small electronic device according to the present disclosure give effects similar to those of the multi-touch method by software even though it uses hardware commonly used (e.g., a touch screen). Therefore, the present disclosure may give a cost-reducing effect.

Other features and aspects will be apparent from the following detailed description, the drawings, and the claims.

### BRIEF DESCRIPTION OF THE DRAWINGS

The above and other objects, features and advantages of the present disclosure will become apparent from the following description of certain exemplary embodiments given in conjunction with the accompanying drawings, in which:

FIG. 1 is a flowchart for illustrating a touch screen control method according to the present disclosure.

FIGS. 2A and 2B are schematic views showing examples of a touch screen apparatus which is operated in a common mode (S100).

FIG. 3 is a schematic view for illustrating a virtual mode according to one embodiment of the present disclosure.

FIGS. 4A and 4B are schematic views for illustrating a first command according to one embodiment of the present disclosure.

FIGS. 5 and 6 are schematic views for illustrating a touch screen control method according to one embodiment of the present disclosure.

FIGS. 7 and 8 are schematic vies showing examples of a zoom-in command at a corner.

FIG. 9 is a schematic view for illustrating the change of a rotating angle according to one embodiment of the present disclosure.

FIGS. 10A to 10C are schematic views showing a rotation command of an object according to the change of the rotating angle.

FIG. 11 is a schematic view for illustrating the switch of an object in a second command according to one embodiment of the present disclosure.

FIG. 12 is another schematic view showing the second command according to the present disclosure.

FIG. 13 is another schematic view showing the second command according to the present disclosure.

FIG. 14 is a flowchart for illustrating that the virtual mode ends.

FIG. 15 is a block diagram exemplarily showing a touch screen apparatus according to one embodiment of the present disclosure.

### DETAILED DESCRIPTION OF EMBODIMENTS

The advantages, features and aspects of the present disclosure will become apparent from the following description of the embodiments with reference to the accompanying drawings, which is set forth hereinafter. The present disclosure may, however, be embodied in different forms and should not be construed as limited to the embodiments set forth herein. Rather, these embodiments are provided so that this disclosure will be thorough and complete, and will fully convey the scope of the present disclosure to those skilled in the art. The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

Hereinafter, exemplary embodiments will be described in detail with reference to the accompanying drawings.

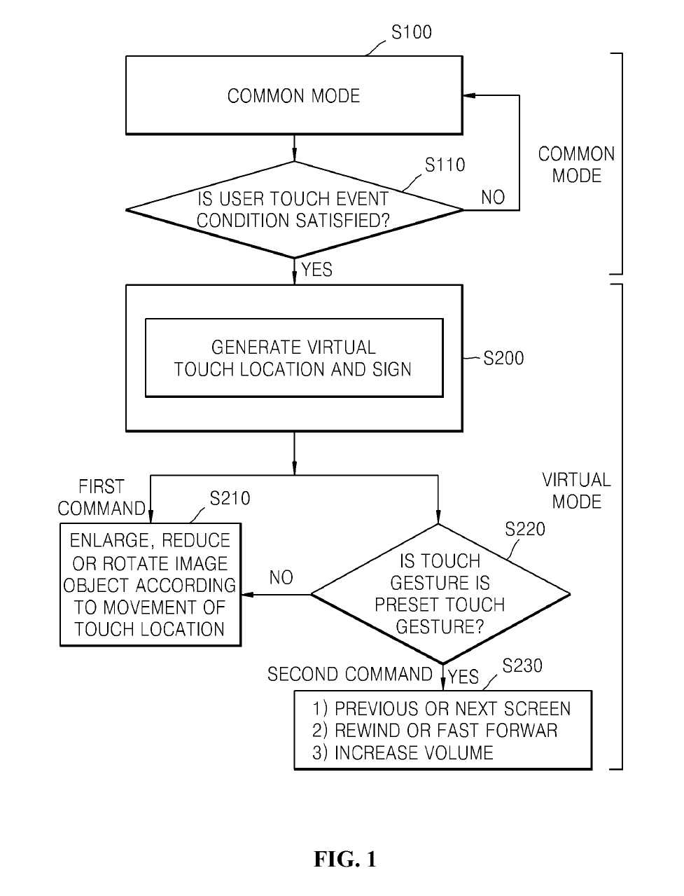

FIG. 1 is a flowchart for illustrating a touch screen control method according to the present disclosure.

Referring to FIG. 1, a common touch mode (hereinafter, referred to as a ‘common mode’) in which an object is moved (for example, scrolled in the case of web browsing) is performed. After that, in the case where a user touch event meets a preset condition, a so-called virtual mode in which a new virtual touch location is generated is initiated. Various touch events may be used as the user touch event condition, and for example, a user may touch the same location substantially over a predetermined time (here, the term “substantially” is used in order not to exclude the case where the touch location is minutely changed regardless of the user's intention) or may touch an object over a certain pressure. However, various touch event conditions may be set depending on device environments, and all conditions which may be distinguished from the common touch mode are included in the scope of the present disclosure. In addition, the touch may be a single touch (a touch by a single input means) or multi touches by a plurality of input means. For example, the virtual mode may be initiated in the case where two adjacent touches are detected within a predetermined distance under a multi-touch environment.

In the virtual mode, a virtual touch location is calculated and generated at a location corresponding to the user touch location, and in one embodiment of the present disclosure, a sign is generated at the virtual touch location (S200). The location where the virtual touch location is generated may be a location point-symmetrical to a user touch location in an object. In addition, the virtual touch location may be within a predetermined distance (for example, 3 cm) from the touch location, and in one embodiment of the present disclosure, a finger shape may be used as an example of the sign. However, various shapes such as an arrow, a circle and a rectangle may be used for the sign in addition to the finger shape. For example, the sign may be partially transparent or partially or entirely translucent so that the image object located behind the sign may be well observed.

After that, two kinds of commands are performed according to the touch method, and one of the two kinds of commands is a first command according to the change of a distance of the touch location (S210). As an example of the first command, if the user touch location moves in a direction where the gap between the touch location and the virtual touch location decreases, it is determined to reduce the object (zoom-out), while, if the user touch location moves in a direction where the gap increases, it is determined to enlarge the object (zoom-in). The movement of the touch location may be performed by dragging. Here, the dragging means that the input means moves while keeping contact with the touch screen.

In addition, a second command according to the change of a user touch rotating angle in the virtual mode is disclosed (S220 and S230). A reference point of the rotating angle may be a center point between the user touch location and the virtual touch location, or an initial touch location of a user may be the center point. In other words, in the present disclosure, the object may be enlarged, reduced, moved or switched to the next object according to the distance between the virtual touch location and the user touch location and the change of the rotating angle.

Hereinafter, each step of the method according to the present disclosure will be described in detail with reference to the drawings.

Common Mode

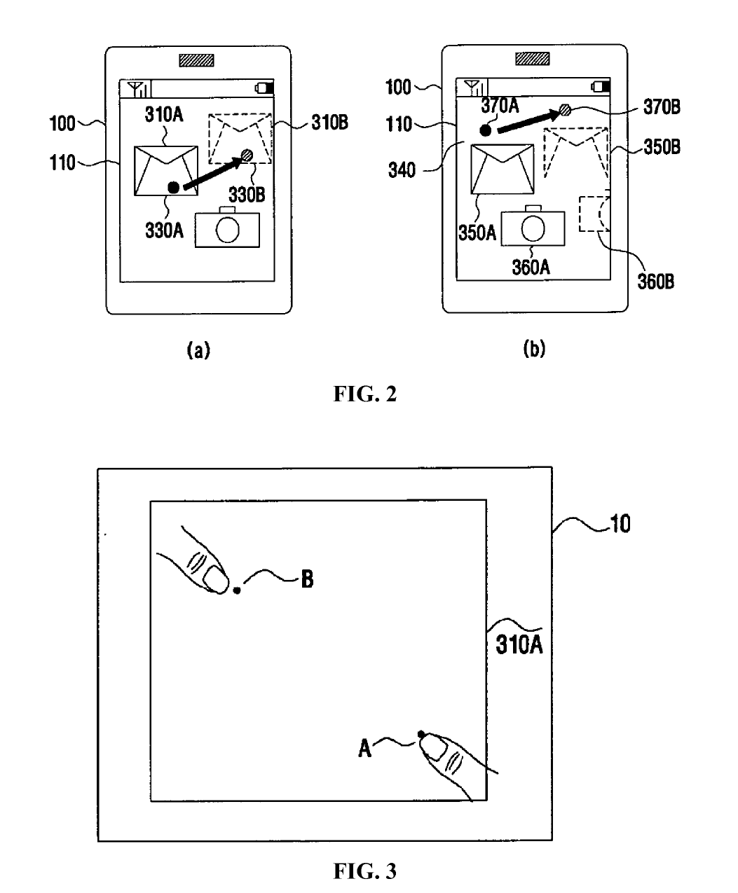

FIGS. 2A and 2B are schematic views showing examples of the touch screen apparatus which is operated in the common mode (S100). Referring to FIG. 2A, if the inside of an object 310A is touched and dragged, the object 310A moves. In FIG. 2A, reference symbols 310A, 310B, 330A and 330B represent an object before the movement, an object after the movement, a touch location before the movement, and a touch location after the movement, respectively.

Referring to FIG. 2B, if an entire screen 340 which is a kind of an object is touched and dragged, the entire screen 340 moves, and objects 350A and 360A included in the background screen 340 also move together. In FIG. 2B, reference symbols 350A and 360A represent objects before the movement, and 350B and 360B represent objects after the movement. In addition, in FIG. 2B, a reference symbol 370A represents a touch location before the movement, and 370B represents a touch location after the movement.

Virtual Mode

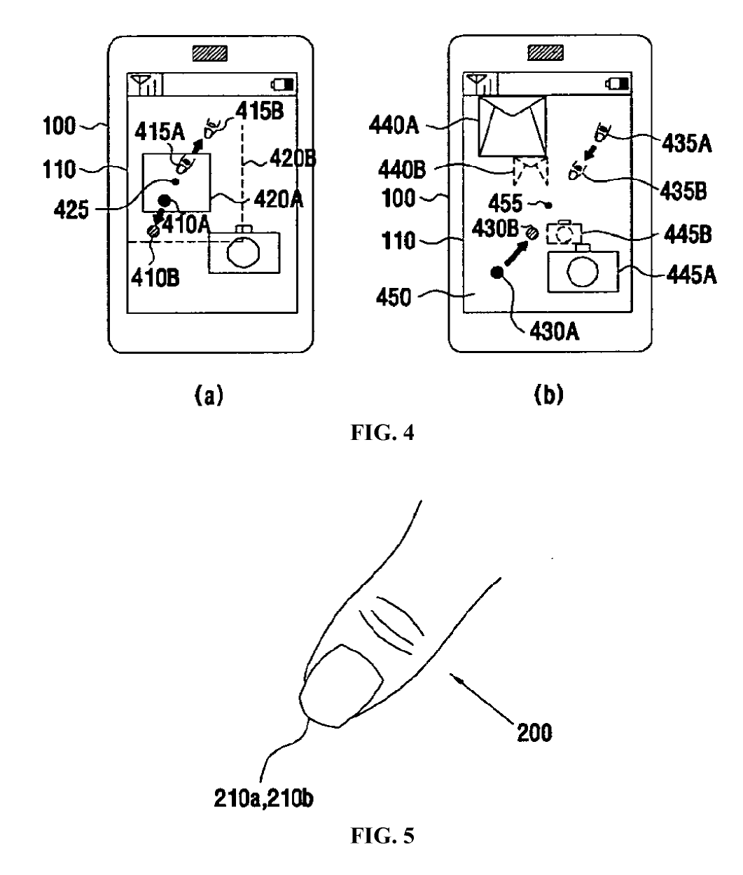

FIG. 3 is a schematic view for illustrating a virtual mode according to one embodiment of the present disclosure.

Referring to FIG. 3, in the case where the user input means (e.g., a finger) touches a specific point A in the object 310A in the touch screen 100 over a predetermined time, a virtual touch location is generated at a location B point-symmetrical thereto based on the center point of the object 310A, and the symmetrical location relationship of the user touch location and the virtual touch location is maintained in the virtual mode. However, the touch event by which the virtual mode is performed may be not only the touch time but also a touch pressure or the like, and the present disclosure is not limited thereto. In addition, the center point may be freely set by the user.

In addition, at the generated virtual touch location, a sign may be displayed for intuitive understanding of the user, and in one embodiment of the present disclosure, the sign has a finger shape. However, the present disclosure is not limited thereto.

After the virtual touch location is calculated and generated according to the touch event condition, two kinds of commands are performed, and one of them is a first command based on the change of a distance between the user touch location and the virtual touch location and the other of them is a second command based on the change of a rotating angle, different from the first command.

First Command

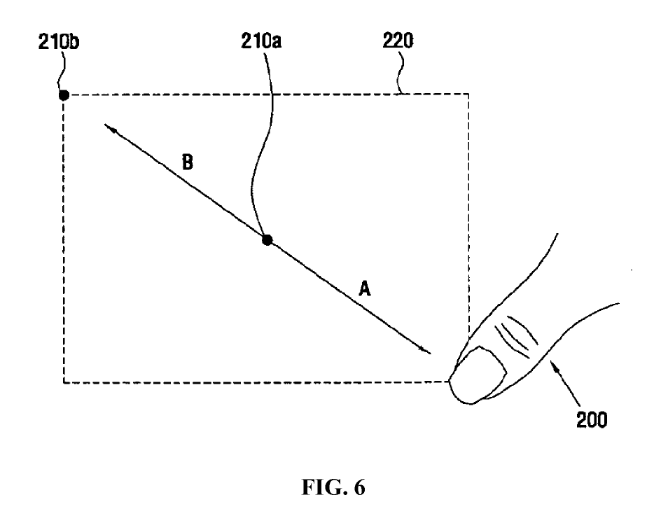

FIGS. 4A and 4B are schematic views for illustrating a first command according to one embodiment of the present disclosure. The first command described below is for enlarging or reducing, but it is just an example of the present disclosure, and another command according to the change of a distance between the user touch location and the virtual touch location may also be used, which also falls within the scope of the present disclosure.

Referring to FIGS. 4A and 4B, if dragging is performed so that the gap between a touch location 410A and the virtual touch location increases, an object 420A is enlarged. In other words, in the case where the touch location 410A of the user moves toward the center of the object, the virtual touch location having a relatively symmetrical relationship thereto moves toward the center identically, which results in decreasing the distance between the touch location 410A and the virtual touch location. On the contrary, in the case where the user touch location moves away from the center, the distance between the touch location 410A and the virtual touch location increases. In the present disclosure, the object is enlarged or reduced by particularly utilizing the relative change of a length. As an example, an enlargement ratio [(square root of the area after enlargement−square root of an initial area)/(square root of the initial area)] of the object 420A may be proportional to a change ratio [(distance after change−initial distance)/(initial distance)] of the distance between the touch location 410A and the virtual touch location. As another example, the enlargement ratio of the object 420A may be proportional to the change ratio of the distance between the touch location 410A and a center point 425. In FIG. 4A, reference symbols 410B, 415B and 420B represents a touch location after the enlargement, a sign after the enlargement, and an object after the enlargement, respectively. As shown in FIG. 4A, the virtual touch location may move along with the movement of the touch location 410A. At this time, the path of the moving virtual touch location may correspond to point symmetry of the path of the moving touch location 410A. The point may be located within the object 420A, and it may be the center point 425 of the object 420A. The virtual touch location may also be fixed regardless of the movement of the touch location 410A, different from the figures.

Referring to FIG. 4B, if the touch location 430A is maintained identically over a predetermined time, a sign 435A is displayed at the virtual touch location. The virtual touch location may be within a background screen 450 which is an object selected by a touch. The touch location 430A and the virtual touch location may have symmetrical relationship based on a center point 455 of the background screen 450. The touch location 430A and the virtual touch location may also not have symmetric relationship based on the center point 455, different from the figures. After that, if dragging is performed so that the gap between the touch location 430A and the virtual touch location decreases, the background screen 450 is reduced, and objects 440A and 445A included in the background screen 450 are also reduced. As an example, a reduction ratio [(square root of the area after reduction−square root of an initial area)/(square root of the initial area)] of the objects 440A and 445A may be proportional to a change ratio [(distance after change−initial distance)/(initial distance)] of the distance between the touch location 430A and the virtual touch location. As another example, the reduction ratio of the objects 440A and 445A may be proportional to the change ratio of the distance between the touch location 430A and the center point 455. In FIG. 4B, reference symbols 430B and 435B represents a touch location after the reduction and a sign after the reduction, respectively. In addition, reference symbols 440B and 445B represent objects after the reduction. Further, in the present disclosure, the virtual touch location is generated at a point identical to the user touch location under the environment where only an enlarging command is demanded, thereby performing an enlarging command in an effective way, as will be described in detail below.

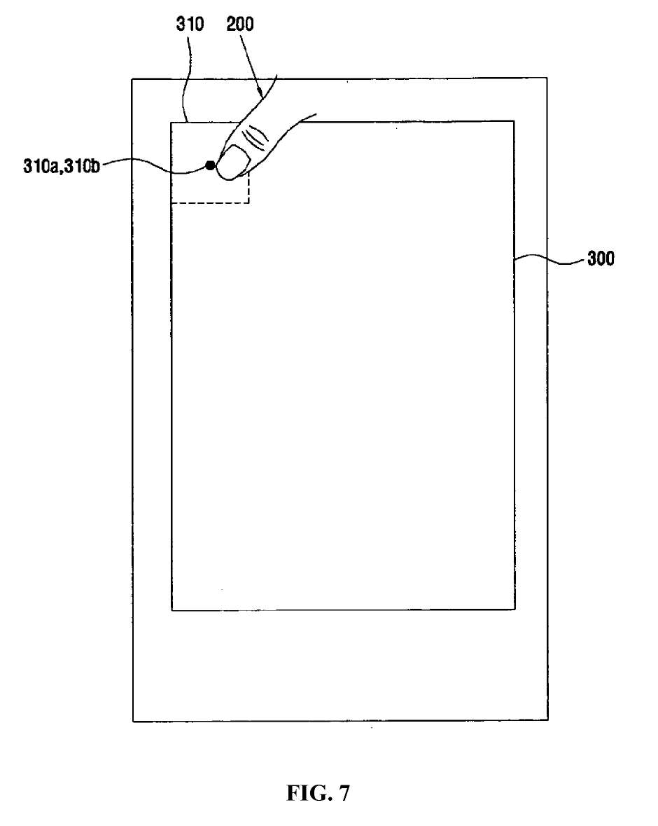

FIGS. 5 and 6 are schematic views for illustrating a touch screen control method according to one embodiment of the present disclosure.

Referring to FIG. 5, a first touch location 210a is firstly detected by a user input means 200 (depicted as a finger in FIG. 5 but not limited thereto). At this time, a virtual touch location 210b is generated at a location identical to the first touch location 210a according to the above touch event condition. In particular, the generation condition of the virtual touch location 210b may be not only the above cases (touch time or pressure) but also a mode shift using a separate input means such as a button. Referring to FIG. 6, the user input means 200 moves in a certain direction A, and at this time, the virtual touch location 210b moves in a direction B symmetrical to the moving direction A of the user input means 200, based on the first touch location 210a. At this time, the distance between the virtual touch location 210b and the touch location of the user input means 200 increases, and in the present disclosure, the enlargement (zoom-in) ratio of the screen 220 is determined in proportion to the distance. In addition, in this embodiment, the virtual touch location 210b is realized with a sign recognizable by a user, for example a finger shape. By doing so, the zooming-in range may be intuitively recognized by the user. However, the sign may not be formed in the virtual touch location 210b, and the sign may have any shape. In particular, in the touch screen control method according to the embodiment of the present disclosure, a zooming-in command at a corner or border may be effectively realized in a device having a relatively small touch panel such as a mobile phone.

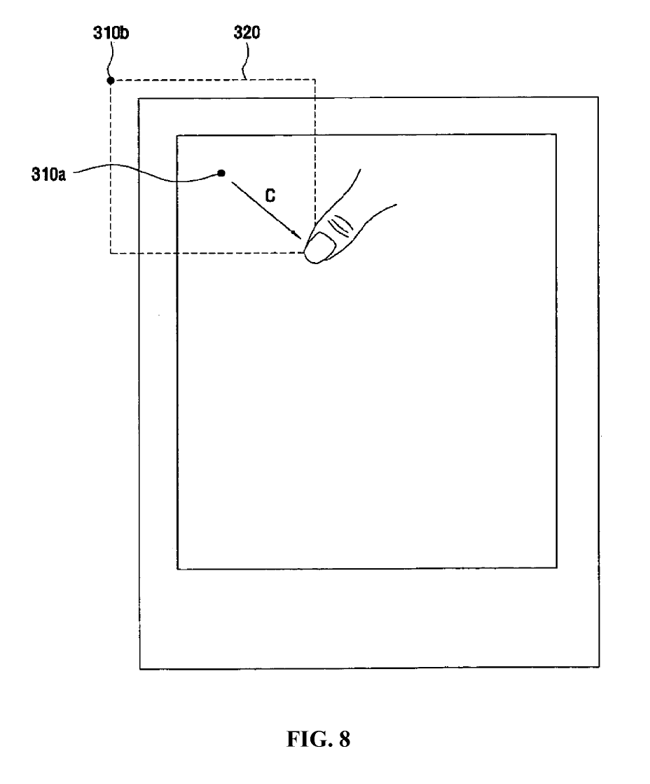

FIGS. 7 and 8 are schematic vies showing examples of a zoom-in command at a corner.

Referring to FIG. 7, if the user input means 200 touches a specific location 310a in an edge region 310 of the zooming-in touch panel display 300 as a condition for generating a virtual touch location, a virtual touch location 310b is generated at the specific location 310a.

Referring to FIG. 8, the user input means 200 then moves in a direction C toward the screen center. At this time, the virtual touch location 310b moves in a direction D symmetrical to the moving direction of the user input means 200 based on the first touch location 310a. Here, the distance between the virtual touch location 310b (or the first touch location 310a) and the user input means 200 is gradually increasing. In the present disclosure, the change of the distance may be used as a zooming-in or zooming-out ratio, and at this time, the zoom-in or zoom-out command may be initiated from the first touch location 310a. Further, since the virtual touch location of the present disclosure is not a physical input means such as a finger, the virtual touch location may expand out of the display 300 of the physical touch panel as shown in figures. It is another advantage of the present disclosure, distinguishable from a general multi touch using two physical input means.

Second Command

In the present disclosure, in the case where a rotating angle is changed by user dragging in the virtual mode performing the first command, a second command different from the first command is performed.

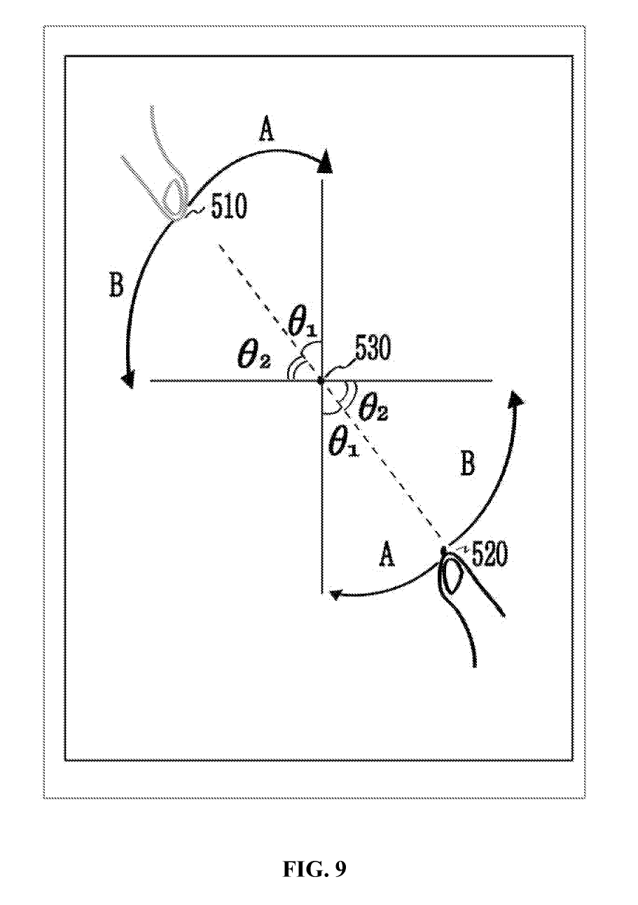

FIG. 9 is a schematic view for illustrating the change of a rotating angle according to one embodiment of the present disclosure.

Referring to FIG. 9, a virtual touch location 510 corresponding to a user touch location 520 is calculated and generated. The virtual touch location 510 corresponds to a location point-symmetrical to the user touch location 520 based on a center point 530, and a rotating angle is generated based on the center point 530 as the user touch location 520 moves. For example, in FIG. 9, it could be understood that a rotating angle is generated as much as θ₂ in case of a clockwise direction B and θ₁ in case of a. counterclockwise direction A. In the present disclosure, the second command is performed using this rotating angle. For example, in one embodiment of the present disclosure, successive commands (for example, rotating an image object) are performed in proportion to the amount of a changing angle, a reference value of the rotating angle is set to an arbitrary value, and then the second command is performed when the rotating angle exceeds the preset reference value.

In particular, the second command is performed in the virtual mode, different from the common mode. Therefore, the command may be more effective and clearly performed, compared with the case where a gesture-based command is recognized and performed in the common mode in which complicated touch gestures are performed. Further, in the case where the rotating angle is continuously changed due to the dragging of the user and thus exceeds the preset value, the second command (for example, object switching) is instantly performed. Therefore, a matching process based on complicated algorithms is not necessary, and the second command may be performed only with comparison of the rotating angle. Therefore, it is possible to rapidly and instantly perform the command.

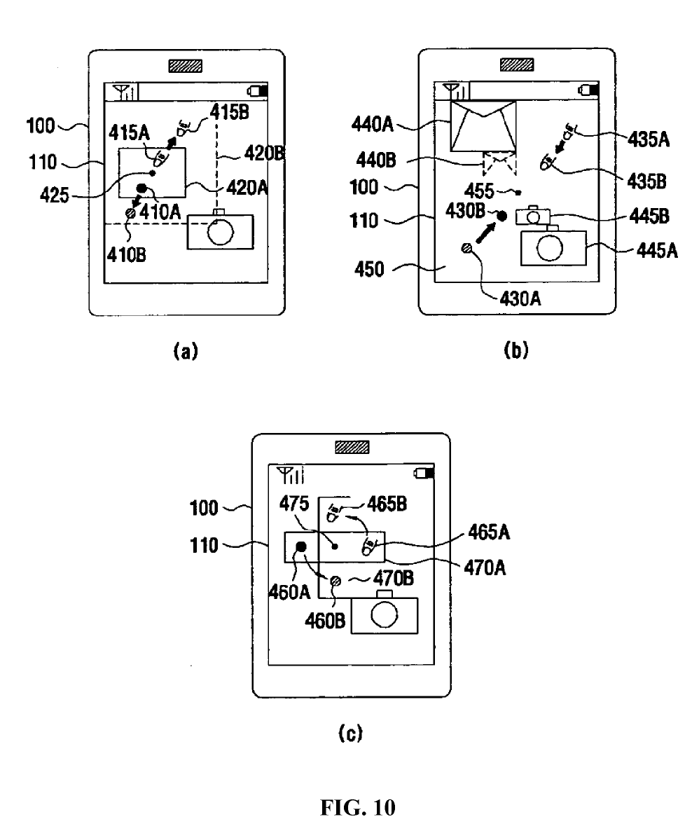

FIGS. 10A to 10C are schematic views showing a rotation command of an object according to the change of the rotating angle.

Referring to FIG. 10C, if a touch location 460A is identically maintained over a predetermined time, a sign 465A is displayed at the virtual touch location. After that, if dragging is performed to change an inclination between the touch location 460A and the virtual touch location, an image object 470A is rotated. As an example, a rotating angle of the image object 470A may be proportional to the change of an inclination between the touch location 460A and the virtual touch location. As another example, the rotating angle of an image object 470A may be proportional to the change of an inclination between the touch location 460A and a center point 475. In FIG. 10C, reference symbols 460B, 465B and 470B represent a touch location after the rotation, a sign after the rotation, and an image object after the rotation, respectively.

In the conventional multi-touch technique, when two fingers are used for rotating, though one rotation is made while keeping two fingers in touch, the rotation hardly exceeds 180 degrees and it is physically impossible to make 360 degree rotation. However, the method of the present disclosure dramatically overcomes the limitation of the conventional multi-touch technique and allows a user to search an object successively as desired and to control a sound volume or the like by only one finger.

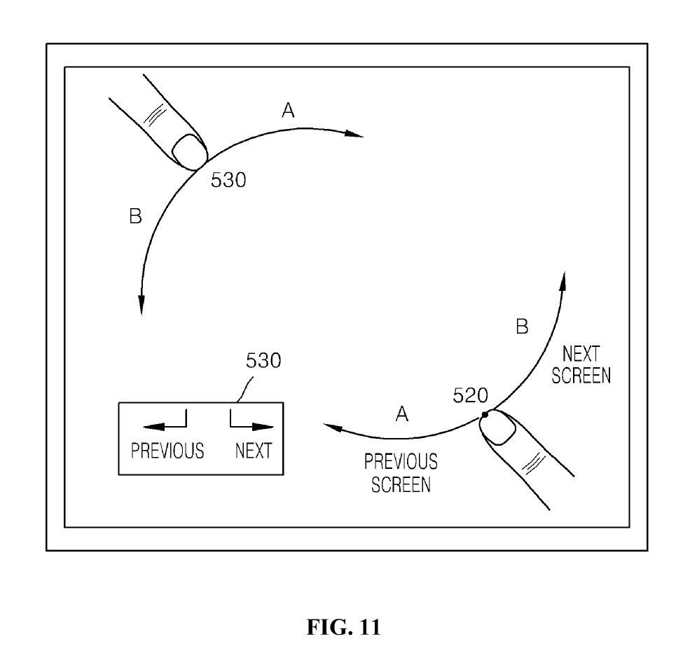

FIG. 11 is a schematic view for illustrating the switch of an object in a second command according to one embodiment of the present disclosure. Here, the object may be a part of the overall screen or the entire screen.

Referring to FIG. 11, a virtual touch location 510 corresponding to a user touch location 520 is generated according to the above touch event condition, and an enlarging or reducing command is performed according to the change of a distance between them. Further, in the case where the user touch location rotates in a clockwise direction A or in a counterclockwise direction B in the virtual mode (or, in the case a rotating angle is generated), the object is switched accordingly to a next screen or a previously screen. In other words, in the case where a rotating gesture in a clockwise direction occurs in FIG. 11, the object (the entire screen) is switched to the next page as a web browsing command, while, in the case the rotating gesture is in a counterclockwise direction, the object is switched to the previous page. This method is very advantageous in comparison to conventional techniques in the point that the object may be switched successively. For example, in the case where a preset command performing rotating angle is A, if a user makes a rotating gesture in a clockwise direction to generate a rotating angle as much as A, the object is switched to a next object. After that, if the rotating angle is generated as much as A again by a successive rotating gesture of the user, the object may be switched to a next or previous object. In other words, in the present disclosure, the user may switch the object unlimitedly by successively rotating only one finger. The switching of an object may also be applied to a plurality of objects, and the object may be successively switched to display a previous or next object. In addition, in consideration of the convenience of the user, the rotating angle information or command information and/or the touch location moving path may be displayed on the screen.

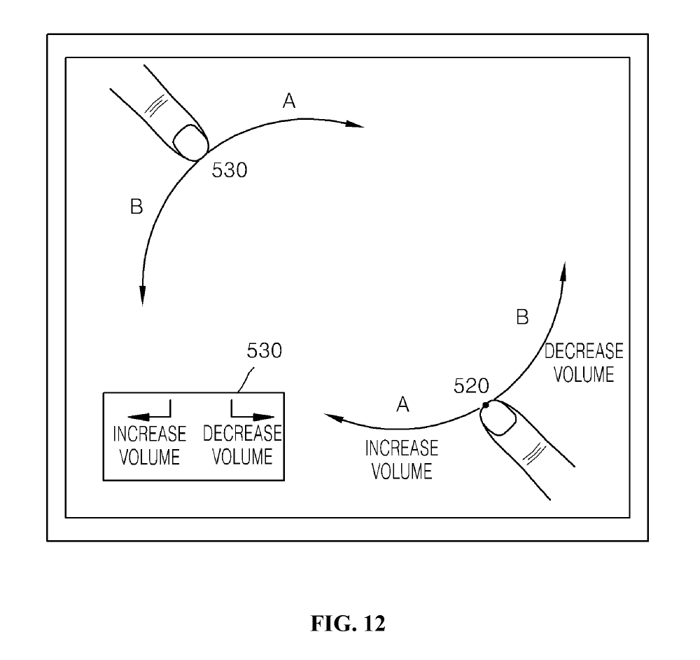

FIG. 12 is another schematic view showing the second command according to the present disclosure.

Referring to FIG. 12, an object may be enlarged or reduced according to the change of a distance of a virtual touch location 510 corresponding to a user touch location 520. Further, in the case where the user touch rotates in a clockwise direction A or in a counterclockwise direction B, the rotation in the clockwise direction increases a sound volume, and the rotation in the counterclockwise direction decreases the sound volume. In this case, the amount of a changing rotating angle of the user touch location 520 and the virtual touch location 510 is applied to determine an amount of increasing or decreasing sound volume. In other words, the sound volume increases when a successive increase of the rotating angle in the clockwise direction is recognized, and the sound volume decreases when an increase of the rotating angle in the counterclockwise direction is recognized. This method may also be applied for successively changing display information such as brightness or contrast as well as voice information such as sound.

In addition, when a command is performed, the command mode according to the present disclosure has continuity and infinity, and therefore the limits of conventional techniques using a scroll bar, in other words the limits in expressivity caused by limitations on display hardware may be easily overcome. For example, in the case of browsing a massive amount of data such as a telephone number list of a mobile phone or a music list, in the conventional technique, the size of a scroll bar is decreased to cause difficult manipulation, and a user may feel more fatigue due to successive panning operations. Further, the scrolling rate is not uniform. However, in the present disclosure, for example in the case where the second command is used, a user may scroll massive data by a regular scrolling amount and exactly find a desired one among the data. In other words, the data may be scrolled up or down according to the rotating direction, and the scrolling-up or scrolling-down operations may be performed successively according to the rotating angle. Further, these operations may be repeated unlimitedly regardless of hardware.

The amount (the degree of increase or decrease of commands) of the first and second commands according to the present disclosure may be adjusted and controlled by a user as desired, advantageously in comparison to the conventional gesture-based command. In addition to the above example, in a command demanding successive increase or decrease (for example, a command whose amount is continuously changed, like sound volume or image brightness), the continuous change of the rotating angle may be in correspondence with the increase or decrease of the command amount. In particular, in the conventional multi-touch technique, when two fingers are used for rotating, though one rotation is made while keeping two fingers in touch, the rotation hardly exceeds 180 degrees and it is physically impossible to make 360 degree rotation. However, the method of the present disclosure dramatically overcomes the limitation of the conventional multi-touch technique and allows a user to search an object successively as desired and to control a sound volume or the like by only one finger.

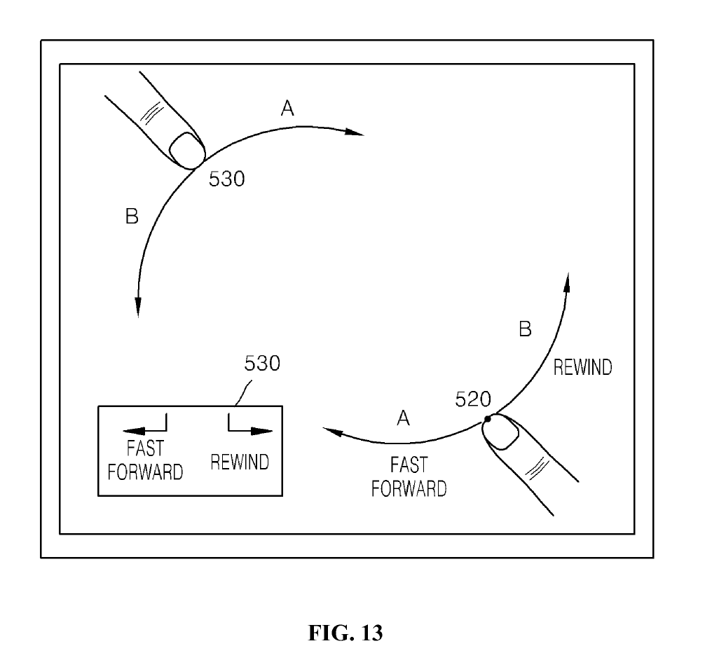

FIG. 13 is another schematic view showing the second command according to the present disclosure.

Referring to FIG. 13, an object may be enlarged or reduced according to a relative location change of a virtual touch location 510 corresponding to a user touch location 520, as described above. Further, in the case where the user touch makes a rotating gesture in a clockwise direction A or in a counterclockwise direction B, the rotation in the clockwise direction performs a fast forward command, while the rotation in the counterclockwise direction performs a rewind command. Similarly, a next or previous moving picture medium may be played based on the movement of touch which generates a rotating angle. At this time, a separate sign (command information or command amount information) representing the second command system based on the rotating angle as shown in figures may be displayed on the screen.

However, the above figures are just for exemplarily illustrating the present disclosure, and all commands performed according to the change of the rotating angle fall within the scope of the present disclosure.

End of Virtual Mode

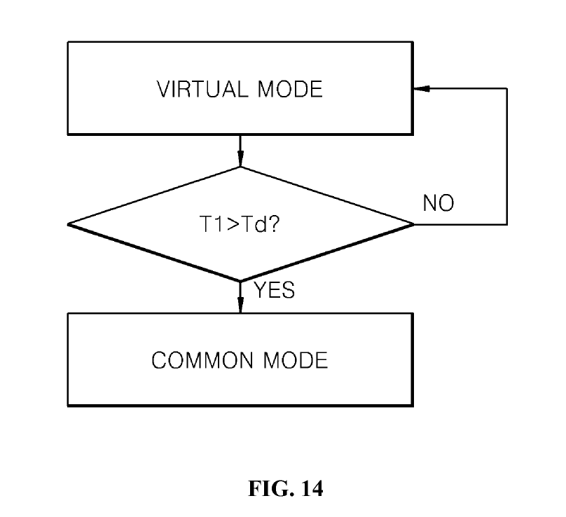

The virtual mode in which the first or second command is performed ends, and the common mode is initiated again. In one embodiment of the present disclosure, the virtual mode ends according to the steps shown in FIG. 14.

Referring to FIG. 14, a time T1 between the time that the touch on the touch screen is terminated in the virtual mode and the time that the touch is resumed is firstly compared with a preset reference time Td. After that, if T1 is greater than Td, the virtual mode ends. If T1 is smaller than Td, the virtual mode is maintained. In this case, it is possible to solve the problem that a user resumes the touch event in order to maintain the virtual mode.

Further, in one embodiment of the present disclosure, a configuration for maintaining a sign at the virtual touch location during the preset reference time Td is disclosed. In this case, the sign slowly disappears as time goes. In particular, in the case where the disappearing time is set as the preset reference time Td, a user may estimate the maintaining time of the virtual mode using the sign.

Touch Screen Apparatus

A touch screen apparatus for implementing the above method is disclosed.

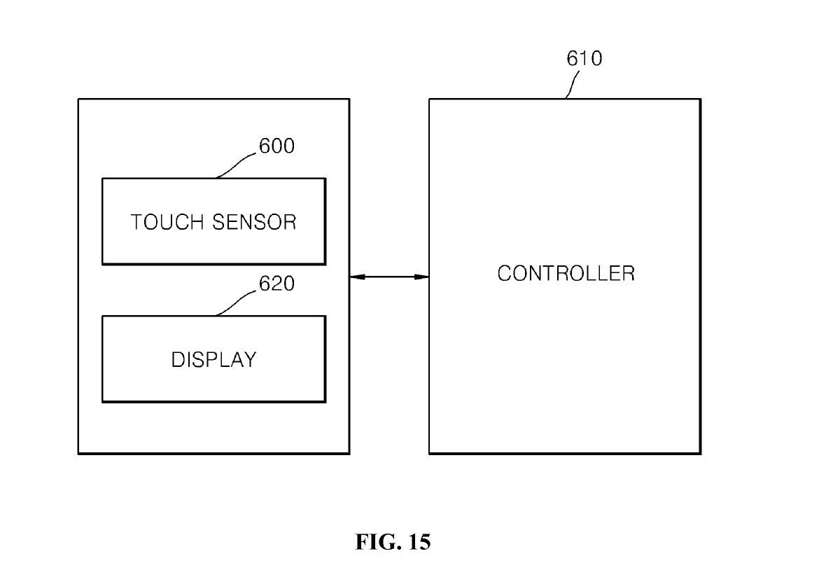

FIG. 15 is a block diagram exemplarily showing the touch screen apparatus according to one embodiment of the present disclosure.

Referring to FIG. 15, the touch screen apparatus according to the present disclosure includes: a touch sensor 600 for sensing a touch location; a controller 610 for calculating and generating a virtual touch location corresponding to the touch location in the case where the touch of a user sensed by the touch sensor corresponds to a preset event, and performing a first command based on the change of a distance between the touch location and the virtual touch location or a second command based on the change of a rotating angle; and a display 620 controlled by the controller 610 to display a sign at the virtual touch location and to display an object which performs the command.

The touch screen may use a resistive-type, capacitive-type surface acoustic wave (SAW) type or infrared (IR) type touch screen. The touch screen includes a display 620 and a touch sensor 600 mounted to the display 620.

The touch sensor 600 senses a touch location. The touch location means a location where an input means (not shown) such as a finger, a hand or an article contacts (touches) the touch screen. The display 620 displays a sign and an object. The display 620 is controlled by the controller 610. The display 620 may be liquid crystal display (LED) or organic light emitting display (OLED). The object means a unit allowing image processing (e.g., image dislocation or deformation). The object may be, for example, a background screen, an icon or a window for an application program (e.g., Word, Excel or Internet explorer). The object may be, for example, an image object displayed on a partial or entire region of the touch screen.

The controller 610 calculates and generates a virtual touch location corresponding to a user touch location in the case where a predetermined touch event occurs. Here, the virtual touch location means a location where a sign is displayed on the touch screen as described above, and the sign may any shape. In other words, in one embodiment of the present disclosure, the sign has a virtual finger shape, but the present disclosure is not limited thereto. The virtual touch location may be generated in a region other than the touch location or generated at the same point as the touch location. In addition, the virtual touch location may be moved along with the movement of the user touch location. At this time, the virtual touch location may correspond to point symmetry to the touch location, and the center point of the point symmetry may be a reference point which determines the rotating angle.

The controller 610 performs two command systems described above by generating a virtual touch location. One of them is the first command of an object based of a distance, and the other is the second command based on a rotating angle, different from the first command. The patterns applicable by the first and second commands are described above, and they are not described again here.

The touch screen apparatus according to the present disclosure may be used for any electronic device using a touch screen. In particular, the touch screen apparatus according to the present disclosure may be applied to small electronic devices in which a touch environment by one hand is more important, for example portable small electronic devices like mobile phones, PDAs, and MP3. Further, the present disclosure may be applied to a large screen or a table top, and in this case, the user may zoom-in or rotate an object without stretching out both hand several times.

The touch screen control method and the touch screen apparatus according to the present disclosure have advantages in that an image object may be moved, enlarged, reduced and rotated in a single touch manner (for example, by a touch using a single finger). In particular, in the case of a portable small electronic device according to the present disclosure, an image object may be moved, enlarged, reduced and rotated by using only a thumb of a hand gripping the portable small electronic device. Further, even in a large touch screen, the limit of a conventional technique, which is restricted to the breadth of both hands, may be overcome. Therefore, the touch screen control method according to the present disclosure has a very useful value in the touch screen-based industries.

1. A touch screen control method, comprising:
generating a virtual touch location corresponding to a touch location according to a touch event condition of a user; and
moving the virtual touch location corresponding to the movement of the user touch location to perform at least one of following commands: i) a first command according to the change of a distance between the user touch location and the virtual touch location and ii) a second command according to the change of a rotating angle caused by a touch of the user, which is different from the first command.

2. The touch screen control method according to claim 1, wherein a sign is displayed at the virtual touch location.

3. The touch screen control method according to claim 1, wherein the touch event condition of the user is that a touch is maintained substantially at the same location over a predetermined time.

4. The touch screen control method according to claim 1, wherein the touch event condition of the user is that a touch pressure of the user is over a predetermined pressure.

5. The touch screen control method according to claim 1, wherein the touch event condition of the user is that two or more touches occur at the same location within a predetermined time.

6. The touch screen control method according to claim 1, wherein the touch event condition of the user is that two or more touches occur at once within a predetermined distance.

7. The touch screen control method according to claim 1, wherein the movement of the user touch location is dragging.

8. The touch screen control method according to claim 1, wherein the virtual touch location corresponds to point symmetry to the user touch location.

9. The touch screen control method according to claim 1, wherein the sign is displayed on the touch screen even when the user touch location is moving.

10. The touch screen control method according to claim 1, wherein the virtual touch location is moved along with the movement of the user touch location.

11. The touch screen control method according to claim 1, wherein the sign is partially transparent, or the sign is partially or entirely translucent.

12. The touch screen control method according to claim 1, wherein the rotating angle is calculated from a center point between the virtual touch location and the user touch location.

13. The touch screen control method according to claim 1, wherein a moving path of the user touch location or the rotating angle is displayed on the touch screen.

14. The touch screen control method according to claim 1, wherein the amount of the second command performed is determined in proportion to the amount of the changing rotating angle.

15. The touch screen control method according to claim 1, wherein the first or second command is an object enlarging or reducing command.

16. The touch screen control method according to claim 1, wherein the first or second command is an object rotating command.

17. The touch screen control method according to claim 1, wherein the first or second command is any one of the following commands:
rotation of an object;
switching to a previous or next object;
performing of a previous or next moving picture medium;
rewinding or fast forward of a moving picture medium;
increase or decrease of display or voice information; and
scrolling up or down of a data list.

18. The touch screen control method according to claim 15, wherein the object enlarging or reducing command is the first command, and wherein the object reducing command is performed when the user touch location moves in a direction where a gap between the user touch location and the virtual touch location decreases, while the object enlarging command is performed when the user touch location moves in a direction where the gap increases.

19. The touch screen control method according to claim 16, wherein the object rotating command is the second command, and wherein the object rotating command is performed when the user touch location moves in a direction where an inclination between the user touch location and the virtual touch location changes.

20. The touch screen control method according to claim 1, further comprising: after the controlling of the touch screen to perform the first or second command, terminating the controlling of the touch screen in the case where a time gap between the end of a user touch and the restart of the user touch is greater than a predetermined reference time; and
keeping the controlling of the touch screen in the case where the time gap is smaller than the predetermined reference time.

21. The touch screen control method according to claim 20, wherein the sign slowly disappears when the controlling of the touch screen is terminated.

22. The touch screen control method according to claim 1, further comprising:
in the case where the touch of the user does not correspond to the touch event condition, controlling the touch screen so that the object is moved along with the movement of the user touch location, without displaying the sign.

23. A touch screen control method, comprising:
generating a virtual touch location at the same location as a first touch location of a user input means;
moving the virtual touch location symmetrically to a moving direction of the user input means based on the first touch location as the user input means moves; and
enlarging or reducing a screen in correspondence with the change of a distance between the user input means and the virtual touch location.

24. The touch screen control method according to claim 23, wherein the virtual touch location is generated when the user input means touches the first touch location over a predetermined time, when a touch pressure of the user input means is over a predetermined pressure, or when the first touch location of the user input means is within a specific region on the display.

25. The touch screen control method according to claim 22, wherein the virtual touch location is extendable to the outside of the display.

26. The touch screen control method according to claim 22, wherein the generating of the virtual touch location further includes generating a recognizable sign at a location where the virtual touch location is generated.

27. A touch screen apparatus, comprising:
a touch sensor for sensing a touch on a touch screen;
a controller for calculating and generating a virtual touch location corresponding to a user touch location in the case where a touch of a user sensed by the touch sensor corresponds to a preset event condition, and performing at least one of the following commands:
i) a first command according to the change of a distance between the user touch location and the virtual touch location; and
ii) a second command performed according to the change of a rotating angle of the user touch location and different from the first command; and
a display controlled by the controller to display a sign at the virtual touch location and to display an object to which the command is performed.

28. The touch screen apparatus according to claim 27, wherein the touch event condition of the user is that a touch is maintained substantially at the same location over a predetermined time.

29. The touch screen apparatus according to claim 27, wherein the touch event condition of the user is that a touch pressure of the user is over a predetermined pressure.

30. The touch screen apparatus according to claim 27, wherein the rotating angle is calculated from a center point between the virtual touch location and the user touch location.

31. The touch screen apparatus according to claim 27, wherein a moving path of the user touch location or the rotating angle is displayed on the touch screen.

32. The touch screen apparatus according to claim 27, wherein the amount of the second command performed is determined in proportion to the amount of the changing rotating angle.

33. The touch screen apparatus according to claim 27, wherein the virtual touch location corresponds to point symmetry to the user touch location.

34. The touch screen apparatus according to claim 27, wherein the first command is an object enlarging or reducing command.

35. The touch screen apparatus according to claim 27, wherein the second command is any one of the following commands:
rotation of an object;
switching to a previous or next object;
performing of a previous or next moving picture medium;
rewinding or fast forward of a moving picture medium;
increase or decrease of display or voice information; and
scrolling up or down of a data list.
